(19) United States
(12) Patent Application Publication
(10) Pub. No.: US 2002/0072969 A1
(43) Pub. Date: Jun. 13, 2002

(54) Electronic reward system

(76) Inventors: Stuart Fisher, Northampton (GB); Stuart Roy Haining, Northampton (GB); Michael Raymond Coleman, Leicestershire (GB)

Correspondence Address: BANNER & WITCOFF, 1001 G STREET N W, SUITE 1100, WASHINGTON, DC, 20001, US

(21) Appl. No.: 09/734,764

(22) Filed: Dec. 13, 2000

(51) Int. Cl. G06F 17/60

(52) U.S. Cl. 705/14; 705/10

(57) ABSTRACT

A user submits a set of personal and lifestyle questions to an electronic reward system, which calculates from the answers an estimated lifetime value based on the user's life expectancy and lifestyle, such as an estimated lifetime spend. The system selects a set of offers, provided by sponsors, to the user based on the answers provided. The user may select any one of the offers and is then transferred to another system provided by the corresponding sponsor in order to complete a transaction involving the offer. Some or all of the information provided by the user to the reward system may, with the user's consent, be copied to the sponsor's system. In another aspect, the estimated lifetime value is used in a game involving guessing the value. In another aspect, users provide information about themselves to a database, and in return an equity share in a company that administers the database is provided to a party nominated by the user. The company then licenses the database in return for revenue.

### BACKGROUND OF THE INVENTION

The present invention relates to an electronic system for administering a reward scheme, particularly for use over a communications network such as the Internet.

In current marketing and sales strategies, substantial sums are spent on advertising products and services to potential customers, including direct recruitment costs, retention and loyalty budgets and operational costs. These costs must then be factored into the selling price of the products and services. In other words, customers are paying for giving their custom to a manufacturer, retailer or service provider. However, advertising is thought to be necessary to bring the product or service to the customers' attention.

The Internet has greatly improved the ease with which potential customers can obtain information about products or services and sellers can obtain information about potential customers. For example, U.S. Pat. No. 6,014,634 describes a system for delivering shopping incentives to supermarket customers over the Internet. As another example, the ‘freeloader.com’ website offers free game downloads in return for information about the customer.

U.S. Pat. Nos. 5,794,210 and 5,855,008 describe various methods for providing a reward to users in return for their attention to advertising material or for providing personal details to advertisers.

Hence, there are opportunities for new business methods that provide incentives to potential customers by redistributing advertising expenditure directly to customers in return for their participation and continued loyalty.

### SUMMARY OF THE INVENTION

According to one aspect of the present invention, there is provided an electronic reward system in which a user answers a set of questions, relating for example to age, income and spending habits. The system calculates from the answers an estimate of the total lifetime spend of the user. The system further selects and displays a set of contracted offers from participating sponsors of the scheme to the user in accordance with the answers provided. The offers may be ranked according to their value to the user based on additional information provided by the user. Sponsors of the system provide the offer details to the system. The user may select any one of the offers and are then transferred to another system provided by the corresponding sponsor in order to complete a transaction involving the offer. A commission may automatically be transferred from the sponsor's system to the reward system in response to the user's selection. Some or all of the information provided by the user to the reward system may, with the user's consent, be copied to the sponsor's system. Rewards may be issued upon completing the initial contract, upon fulfillment of the contract, or periodically while the contract continues.

According to another aspect of the invention, there is provided an electronic tracking system that monitors user performance of a contract and determines whether to present further offers to a user based on the monitored user performance. An aggregated user performance over multiple contracts may be monitored, and future offers presented based on the aggregated performance.

According to another aspect of the invention, there is provided an electronic game system in which a user answers a set of questions, relating for example to age, income and spending habits. The system calculates from the answers an estimate of the total lifetime spend of the user, and prompts the user to guess the user's total lifetime spend. Points, rewards or other credits may then be accrued to the guesser according to whether the guess is close or equal to the estimate by the system.

According to another aspect of the present invention, there is provided an electronic reward system in which users provide information about themselves to a database. In return for the information being provided, updated and/or expanded, an equity share (stock) in a company which administers the database is provided to a party nominated by the user, such as a child, a friend, a charity or themselves. Use of the database is then licensed by the company in return for revenue to the company. Hence, the value of the data for marketing and sales purposes is returned to the providers of the data. Communications may be sent to users to prompt them to update their details or to provide new information.

### BRIEF DESCRIPTION OF THE DRAWINGS

Embodiments of the present invention will now be described with reference to the drawings, in which:

FIG. 1 is a diagram of an Internet-based system through which a first embodiment of the invention is operated;

FIG. 2 is a diagram showing the sequence of the display screens shown in FIGS. 3a to 3j;

FIGS. 3a to 3j show a sequence of screen displays during the operation of a preferred embodiment; and

FIG. 4 is a diagram of an Internet-based system through which a second embodiment of the invention is operated.

### DESCRIPTION OF PREFERRED EMBODIMENTS

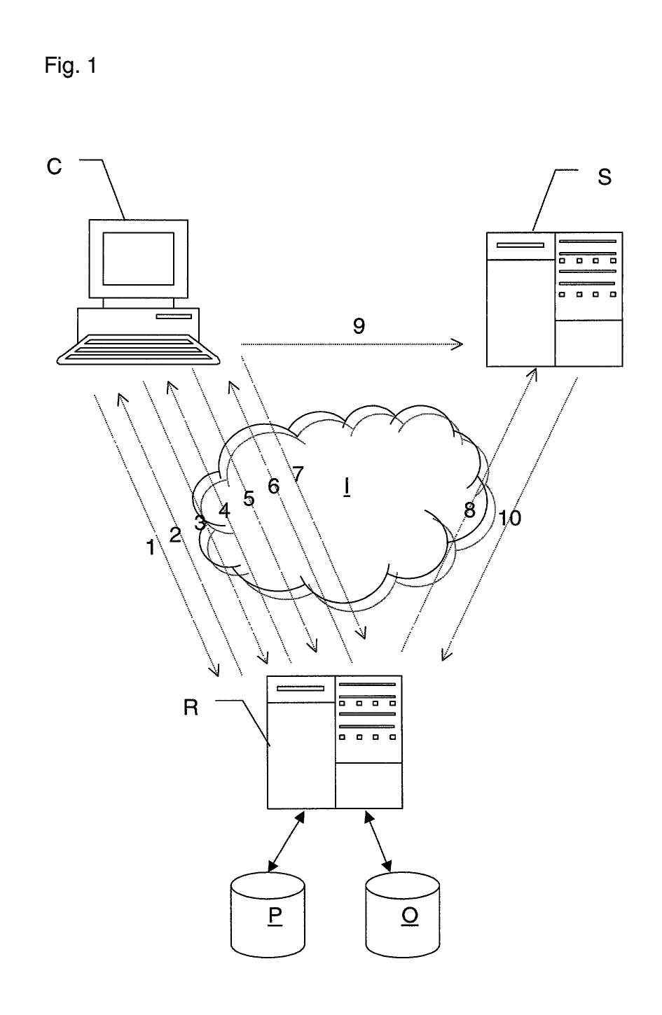

Embodiments of the present invention are preferably implemented over the World Wide Web by connection through the Internet I, as shown in FIG. 1 and involve transactions between client terminals C, a reward system server R and one or more sponsor servers S. A browser application running on the client terminal C receives and displays information provided by the reward system and/or sponsor servers C, S and allows data to be input by the user and submitted to those servers, in a manner well-known in the art.

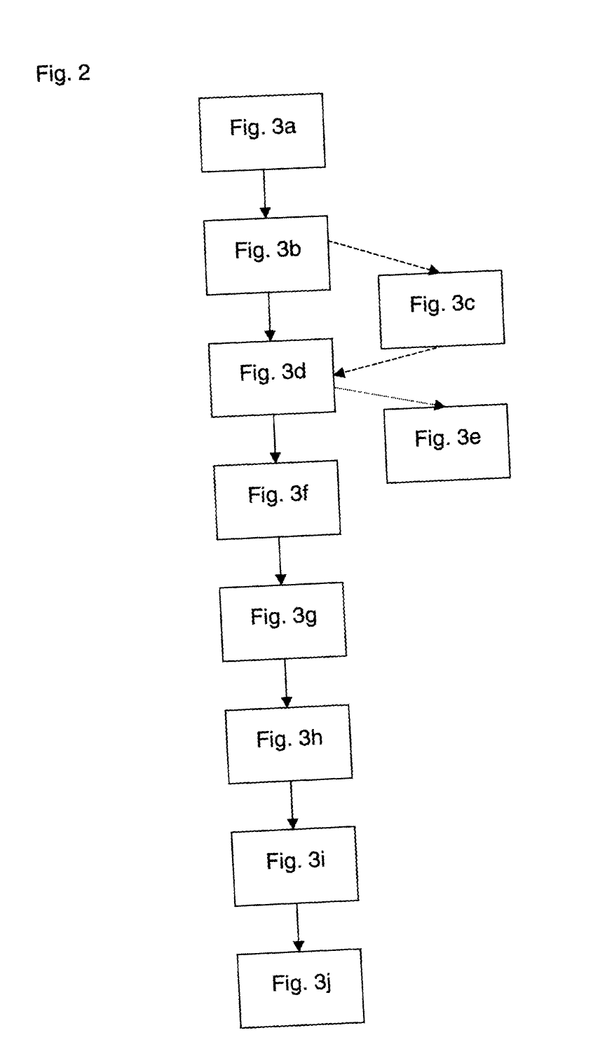

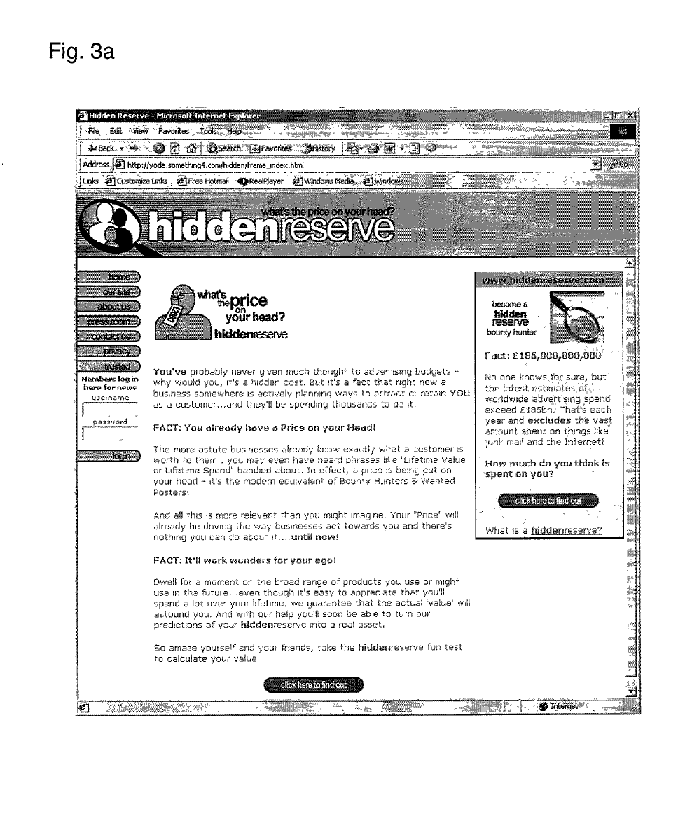

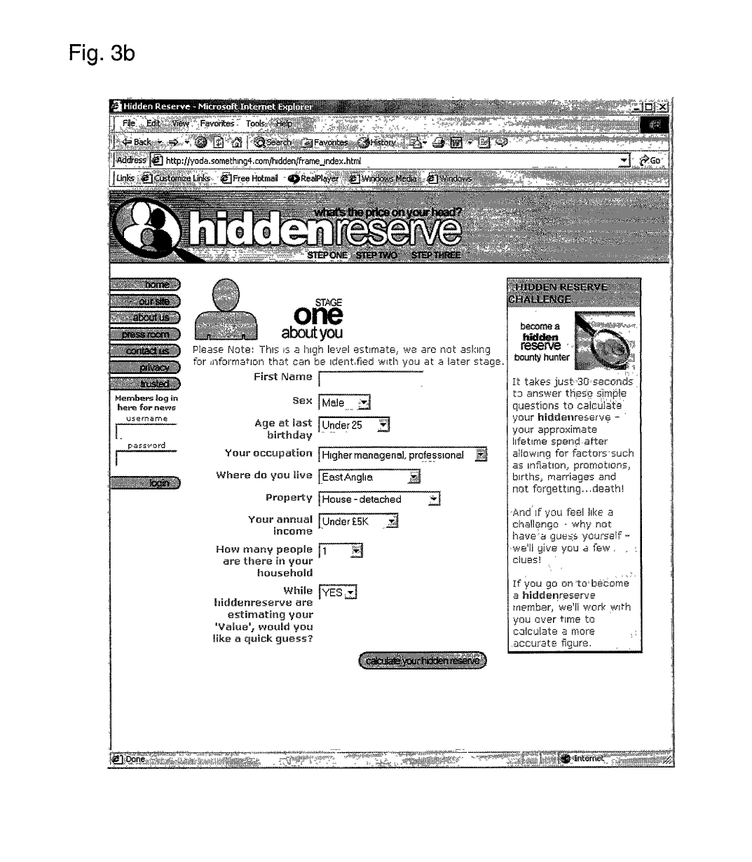

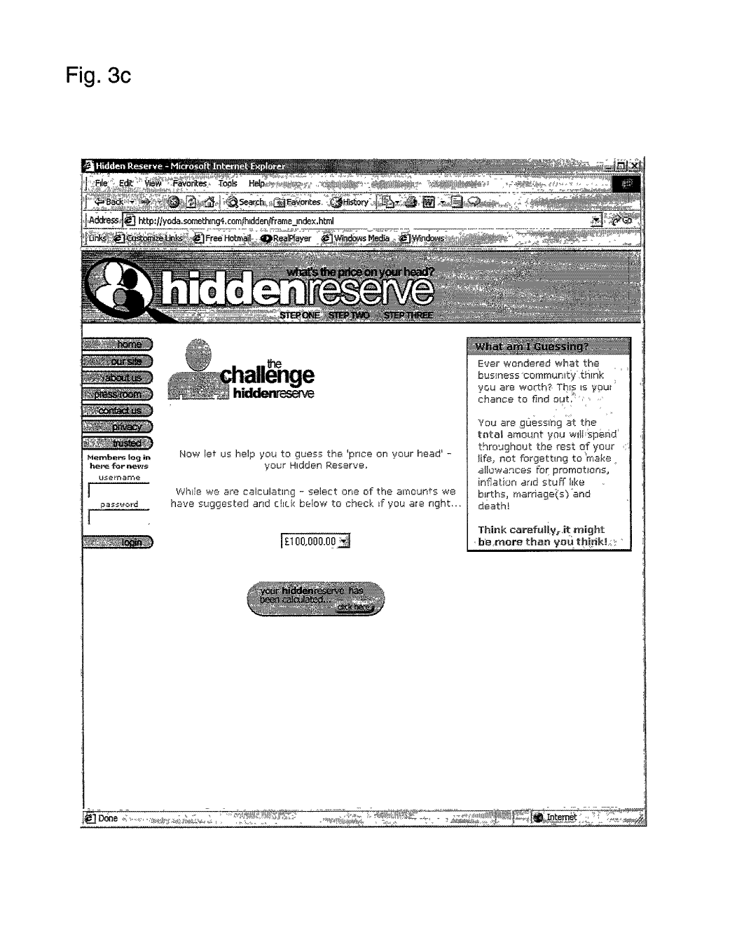

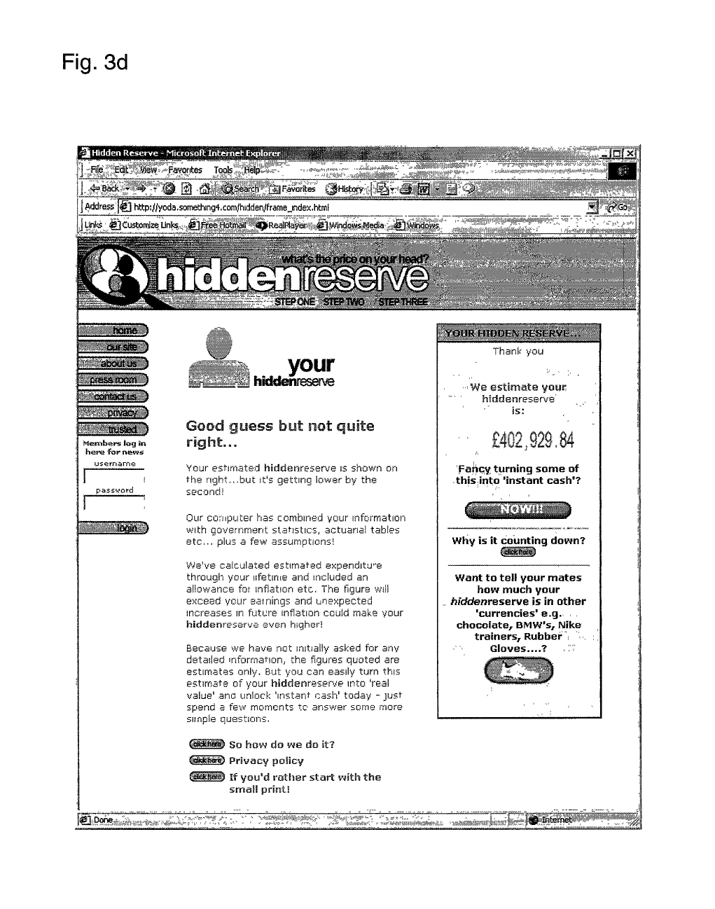

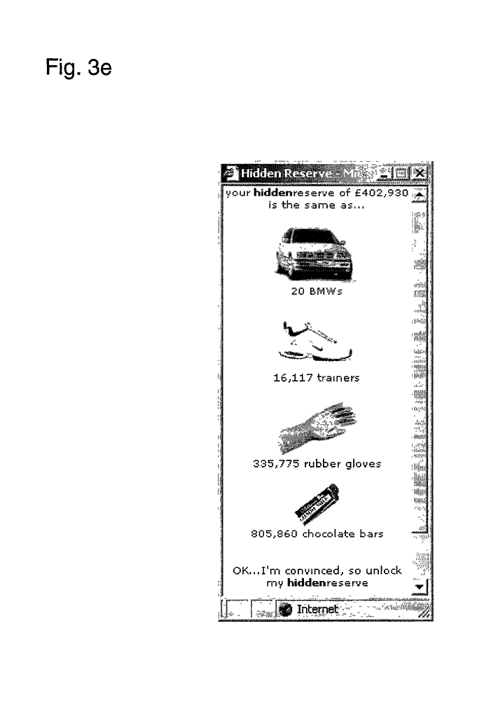

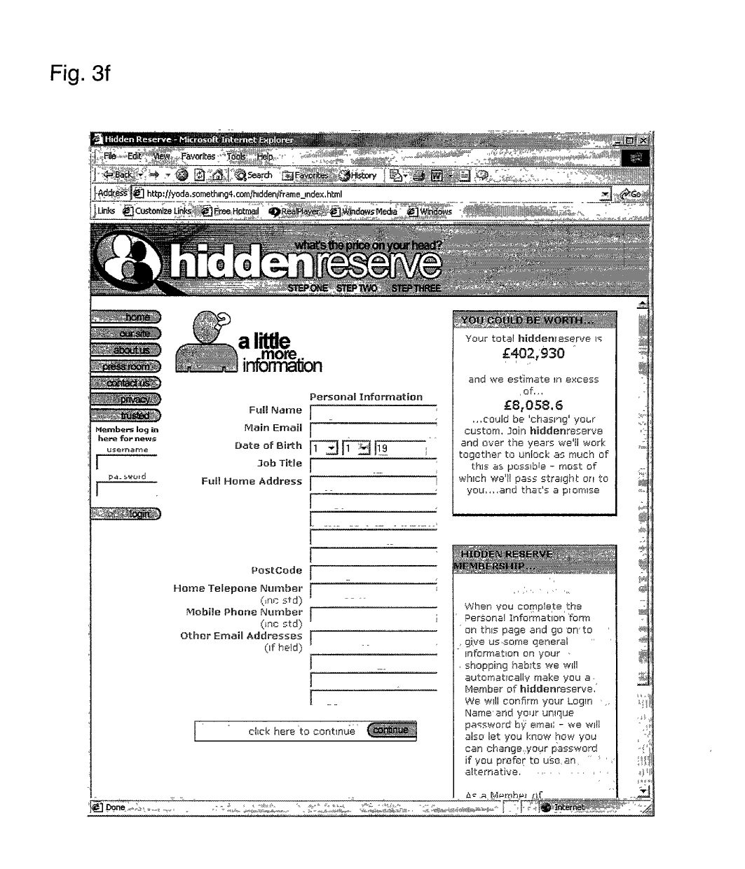

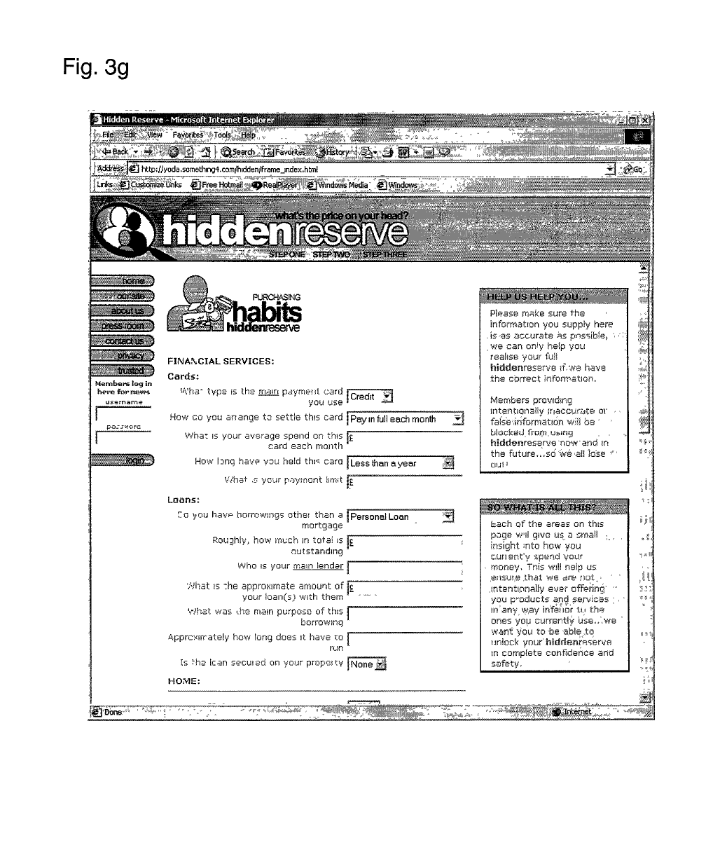

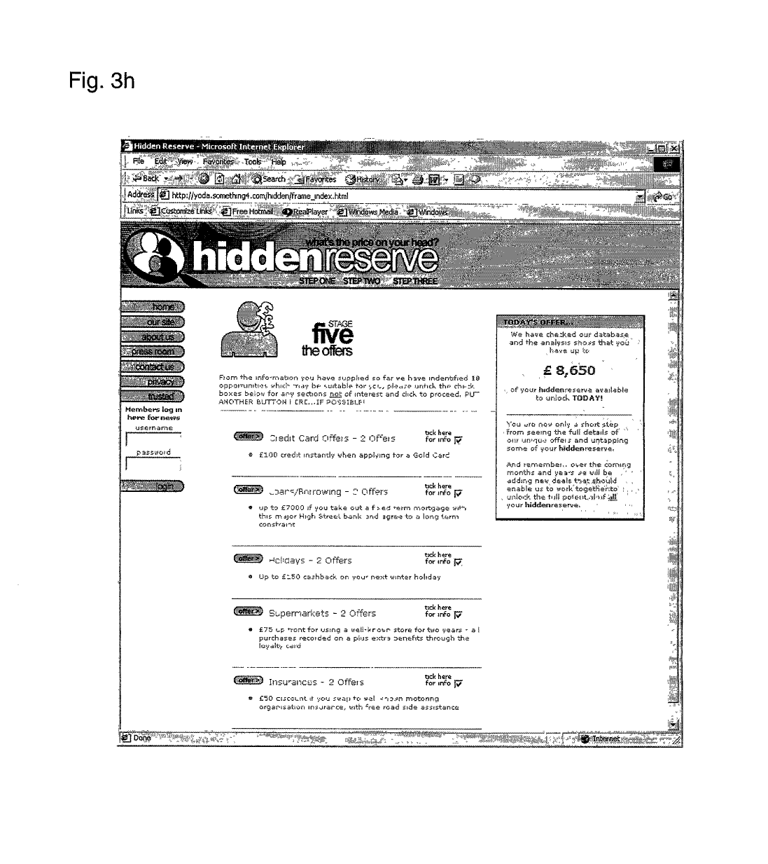

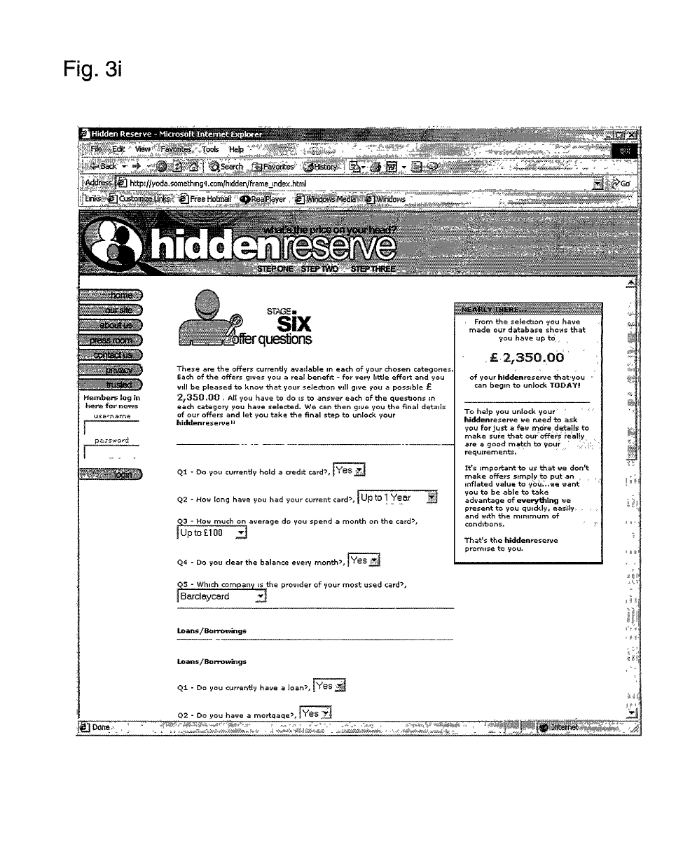

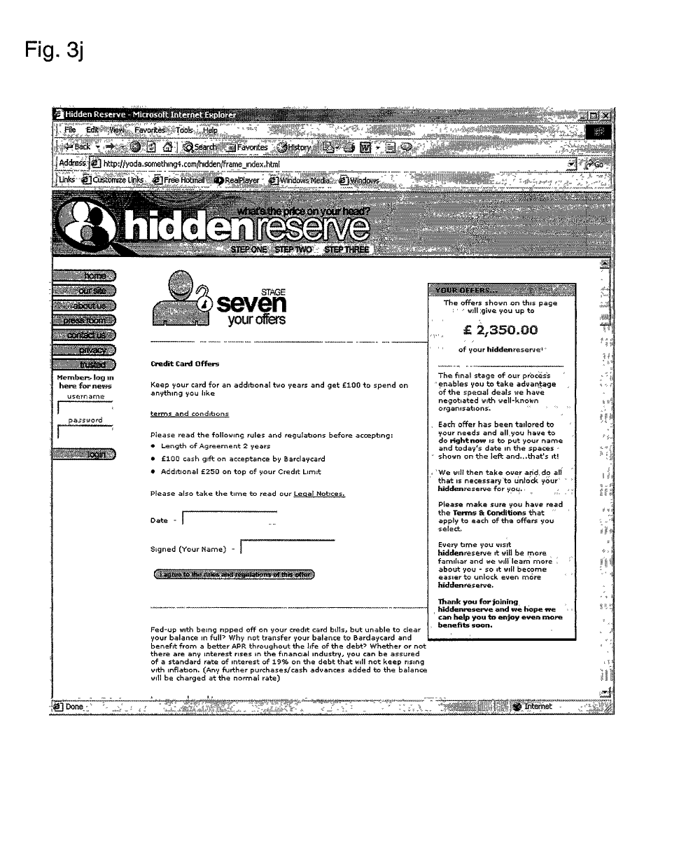

A first embodiment will now be described with reference to FIGS. 3a to 3j of the accompanying drawings. FIG. 2 shows the sequence with which the screens shown in FIGS. 3a to 3j are displayed. The display of FIG. 3c is an optional intermediate display between those shown in FIGS. 3b and 3d. The display of FIG. 3e is displayed in a separate window, which may be closed by the user, or automatically.

A user connects the client terminal C to the Internet I, launches the browser application and enters or selects the address of the reward system server R. A home page as shown in FIG. 3a is then displayed by the browser, which explains the concept of the system (referred to as ‘hiddenreserve’ in FIGS. 3a to 3j). Existing members may log in from the home page, but new visitors are invited to click on a button which takes the browser to the ‘Stage One’ screen as shown in FIG. 3b. At this stage, the user is prompted to enter their first name, sex, age, occupation, location, type of residence, annual income, and number of people in household. All but the first of these is selected from a drop-down list. The entered data is submitted to the reward server R at step 1 shown in FIG. 1.

On the basis of the information provided, the reward server R calculates an estimated lifetime spend for the user, in other words their total expenditure from the current time until their death. This figure is an important measure of the net worth of the user for the purposes of selling and marketing to that user. However, before this sum is calculated, the user may optionally choose to input an estimate of their lifetime spend, by selecting this option on the browser display, in response to which a ‘Challenge’ page is displayed as shown in FIG. 3c. A drop-down list of estimated spends is displayed; the user selects one and then clicks the button below to initiate the estimated spend calculation by the reward server R.

The reward server R calculates the estimated lifetime spend using an algorithm taking as input the information provided by the user and further information extracted from an actuarial database accessible by the reward server R. The estimated lifetime spend is then transmitted to the client terminal C as shown in step 2 of FIG. 1, and displayed on a page as shown in FIG. 3d. From that page, the user may click a button which opens another browser page, as shown in FIG. 3e, to display the estimated lifetime spend in terms of different commodities such as cars, training shoes, cars and rubber gloves.

The page shown in FIG. 3d is automatically refreshed at predetermined intervals to update the estimated lifetime spend; this is steadily reduced to take account of time passing and therefore the decreasing estimated time until death.

The page also encourages the user to proceed to the next stage in order to benefit from some of their estimated value. In response to the user clicking a button (labeled ‘NOW!!!’ in FIG. 3d), the page shown in FIG. 3f is then displayed. This page displays a proportion (2% in this example) of the estimated lifetime spend as a value which could be obtained by the user through the reward system. The page also includes a form into which the user enters more detailed personal information, such as full name, address, email address and telephone number which are used to create a membership record for the user. The user may choose a username and password for logging in as a member, or the username and password may be sent by email to the user.

Once this information has been entered, the user clicks a ‘continue’ button and the page shown in FIG. 3g is then displayed. This page contains a form in which the user enters information relating to their purchasing habits, such as loans and means of payment. Once this information has been entered, the user clicks a button so as to submit the information to the reward server R, as shown as step 3 in FIG. 1. The reward server R stores the submitted data in a personal data database P and uses this data to select individual records from an offers database O.

Each offers record includes at least the following data:

a short description

an offer category

a set of criteria for eligibility for the offer;

the key terms of the offer (i.e. terms of the contract),

a value of the offer, and

an address of one of the sponsor servers S associated with that offer.

The reward server R selects those records which match the information on purchasing habits submitted by the user, sums the values of those offers, and displays the total on a page as shown in FIG. 3h, together with a category section for each category of selected offer. The transmission of the data for this display is shown as step 4 in FIG. 1. Each category section includes the short description of the most valuable offer within that category, and a button, which, when clicked, causes a category page to be displayed, as shown for example in FIG. 3i.

The category page includes a set of questions specific to the selected category, to which the user responds by typing in information and/or selecting options from drop-down lists, and clicking a button to submit the category specific information, as shown as step 5 in FIG. 1. The reward server R then removes from the selected records within that category any offers for which the criteria are not matched by the category specific information, and displays details of the remaining offers within that category (step 6 in FIG. 1), as shown in FIG. 3j. The user may then take up any of these offers by indicating agreement with the displayed terms and conditions (step 7 in FIG. 1), in response to which the reward server R transmits the contact details of the user to the sponsor server S (step 8 in FIG. 1), or by passing the information in a hyperlink from the browser to the sponsor server. The browser may also be redirected to the sponsor server S so as to complete any further transactions which are needed to qualify for the offer (step 9 in FIG. 1).

If the user subsequently completes the transaction with the sponsor to qualify for the offer, a commission may be paid from the sponsor to the reward scheme operator. Commissions may also be paid at the same time as rewards are issued to the user, or at any time agreed between the operator of the system and the sponsor.

If the user fails to complete the transaction, or completes the transaction but subsequently does not comply with its conditions, or the sponsor discovers that the information provided was incorrect, the sponsor may report this compliance data back to the reward scheme operator. The user may be barred from further use of the system, by setting a flag against the user record of that user. Alternatively, sponsors may decide whether to make subsequent offers to such users by specifying that an offer be presented only to users who do not have this flag set. The compliance data may be updated manually on the reward server R or may be provided automatically from the sponsor server S (step 10). Instead of setting a flag, a tally of the number of non-compliance reports may be stored against each user record and further offers may be made to a user if the tally does not exceed a predetermined number. Thus, the system provides a means for a sponsor to select customers who have shown previously loyal behavior, even if only to other sponsors. Sponsors may run token-based loyalty schemes in which tokens are added to a user's account when the user completes a contract, or periodically when the user has continued to honor a contract. Token increments are transmitted to the reward server R for adding to a token account stored against a user record. Tokens may be exchanged for benefits to the user in subsequent offers. Conversely, if the user completes the transaction and complies with all its conditions, the sponsor server S may transmit a confirmation message back to the reward server R. The reward server R may store a count against each user record of the number of confirmations received, and this may be used a criterion for an offer record being selected for a user. In this way, customer loyalty may be rewarded by providing more advantageous offers to users who have previously received loyalty confirmations.

As an additional feature, host websites may provide links to the reward system website, and preferably to a specific offer provided by the reward system. A user following this link will enter the details required for membership or log in if already a member, and will then be taken directly to a page displaying the offer details. Further rewards benefits may be provided to users in this way, with the operator of the host website funding the further rewards.

The offer may take the form of a cost saving, a free gift or service, or any other incentive. As an alternative to the ‘lifetime spend’ algorithm, an ‘environmental impact’ algorithm may be used to calculate a user's lifetime impact on the environment based on personal and lifestyle information provided by the user. For example, the ‘environmental impact’ algorithm may calculate the net CO₂ emissions or tonnage of waste that will be created by the individual, household, place of work etc. for the rest of their life, or the production of goods and services and other such activities required to support the user for the rest of their life. In this case, the offer may take the form of a proposed activity that will reduce one or more of the environmental impact values as calculated by the environmental impact algorithm. For example, the offer may involve the planting of trees in return for the user subscribing to an environmental group, and the offer details may include an estimate of the amount of CO₂ that will be removed from the atmosphere by the trees.

As another alternative to the ‘lifetime spend’ algorithm, a ‘time wasted’ algorithm may be used to calculate the amount of time which will be wasted by the user in unproductive activity in their lifetime, based on the personal and lifestyle information provided by the user. In this case, the offer may involve a proposed time saving feature. For example, if the user has multiple savings, loan and current accounts, the offer may involve subscribing to a unified bank account and the offer details may include an estimate of the time to be saved by the user in checking their accounts and transferring money between them.

As another alternative to the ‘lifetime spend’ algorithm, a ‘hassle factor’ algorithm may be used to calculate the amount of stressful activity which will be undertaken by the user in their lifetime, based on the personal and lifestyle information provided by the user. In this case, the offer may involve a proposed activity replacement feature. For example, if the user has shopping/searching needs a service could be offered to undertake such tasks.

A variant will now be described which makes use of any of the above algorithms in a different context. The algorithm may be used in a game, such as a game show which can be viewed and optionally participated in via television, the Internet, telephone or other communications media. A participant is invited to answer questions similar to those in the ‘Stage One’ page shown in FIG. 3b. The participant, or other participants, then guess the output of the algorithm, such as lifetime spend, CO₂ emissions, time wasted or hassle factor. The supplied information is processed by a computer program running the appropriate algorithm to generate the output. The participant guessing close or closest to the output value then obtains credit within the game.

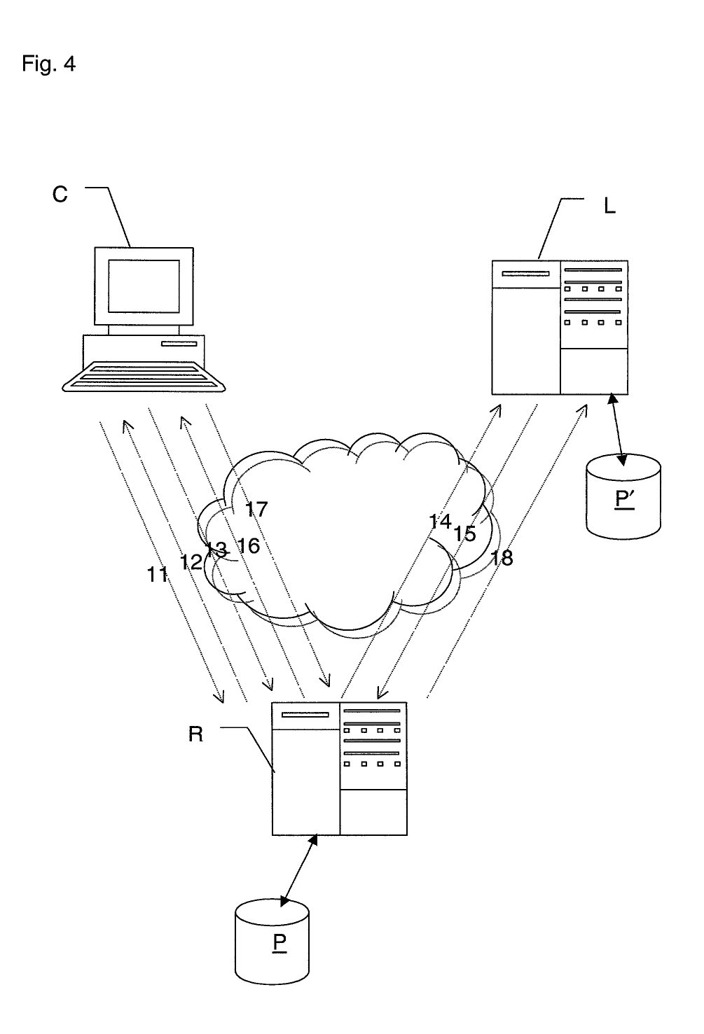

A second embodiment will now be described with reference to FIG. 4. In this embodiment, personal information is provided not to gain access to offers, but to create a personal information database P which is then licensed for the benefit of the participants. The system is accessed over the Internet by client terminals C as shown in FIG. 4, and personal data is input to the database on pages substantially as shown in FIGS. 3f so as to create a membership record for the user (step 11 in FIG. 4). Once the membership record is created, a reward is issued to the user. Preferably, the reward takes the form of an equity share in a company which owns the system. An electronic share record may be created on the personal information database P using the personal details of the user as details of ownership. Alternatively, the user may nominate another person as the owner of the equity share, such as a child, friend, spouse or charity. The reward server R may store an account record for that nominated other person and allow transfer of shares between accounts.

The reward system server R saves as part of each membership record a ‘last updated’ date which records when that member last logged onto and amended their personal details. For all membership records where the ‘last updated’ date is more than a predetermined number of days prior to the current day, the system sends an email (step 12) to the address stored against the membership record prompting the member to log in to the website and update their details (step 13).

The owning company licenses the database of personal information to advertisers, market research companies and the like so as to generate income and provide a dividend to the shareholders. On completion of a licensing agreement, information may be copied from the personal information database P to a licensee's personal information database P′ stored at a licensee's server L. Potential licensees may request (step 15) additional information not already provided by the database which may be required from some or all categories of users. In that case, an additional questionnaire is set up on the system and an email is sent (step 16) to the relevant categories of users, including a link taking them directly to the additional questionnaire. In return for completing the questionnaire (step 17), users are issued with an increased equity share or another type of reward. The collected information is then transmitted to the licensee (step 18).

Instead of issuing shares directly, the system may credit users with points that can be exchanged for shares later or subject to further conditions, or used to enter a prize draw for shares. The points or shares may be used as a quasi currency on the Internet or within a designated shopping area, in exchange for goods and services, in a similar way to Beenz™, MyPoints™ or the like. The points or shares can also be purchased for real currency.

The above embodiments are described only by way of example, and variants of these embodiments may fall within the spirit and scope of the present invention. In particular, other present or future public networks may be used in place of the Internet.

Copyright subsists in the screen displays of FIGS. 3a to 3j and is not waived by virtue of forming part of the present application, save for use permitted by law in the copying of the published patent application. All trademarks that appear in the screen displays are acknowledged.

What is claimed is:

1. In a system comprising a plurality of terminals connected or connectable to a host server and to any of a plurality of sponsor servers over a network, an offer database of offer records each including one or more offer criteria and a sponsor indication indicating one of said sponsor servers, and a user details database, both said databases being accessible to the host server, a method comprising:
a. storing, on the user details database, personal data relating to a user;
b. comparing said personal data to the offer criteria and selecting a subset of said offer records for which the offer criteria match said personal data;
c. transmitting information derived from said selected offer records to one of the terminals associated with said user;
d. receiving a selection indication from said one of the terminals, indicating one of said selected offer records;
e. in response to said selection indication, redirecting said one of the terminals to one of said sponsor servers indicated by the sponsor indication of the selected offer record; and
f. receiving from the sponsor server a compliance indication of compliance with the offer corresponding to the selected offer record.

2. A method according to claim 1, wherein said subset of offer records is further selected based on a compliance record associated with said user.

3. A method according to claim 2, including updating said compliance record in response to said compliance indication.

4. A method according to claim 1, in which step e) includes sending a request for further personal information to said one of the terminals and receiving further personal information from said one of the terminals in response thereto.

5. A method according to claim 1, including transmitting data derived from said personal data to said sponsor server.

6. A method according to claim 1, including calculating a value for said user on the basis of said personal data, and transmitting said value to said one of the terminals.

7. A method according to claim 6, in which said value is dependent on a life expectancy of said user calculated on the basis of said personal data.

8. A method according to claim 7, wherein said value is one of an estimated lifetime spend value, an estimated lifetime environmental impact value, an estimated lifetime time wasted value and a lifetime stress value.

9. A method according to claim 1, wherein each of said offer records includes information indicating an associated value, and step c) includes summing the values associated with the selected offer records to calculate a summed value and transmitting said summed value to said one of the terminals.

10. In a system comprising a plurality of terminals connected or connectable to a host server and to any of a plurality of sponsor servers over a network, a database of offer records each including one or more offer criteria and a sponsor indication indicating one of said sponsor servers, both said databases being accessible by the host server, a method comprising:
a. transmitting, from one of said terminals to the host server, personal data relating to the user;
b. receiving at said terminal, from said host server, information relating to a subset of said offer records for which the offer criteria match said personal data;
c. transmitting a selection indication indicating one of said selected offer records from said terminal to said host server; and
d. conducting a transaction with a sponsor server selected by said host server according to the sponsor indication of the selected offer record;
wherein said subset of said offer records are selected on the basis of a compliance record associated with said user.

11. A method according to claim 10, including, prior to step d), receiving a request for further personal information from said server and, in response thereto, transmitting further personal information from said terminal to said server.

12. A method according to claim 10, including receiving a value at said terminal from said server, said value being dependent on said personal data.

13. A method according to claim 12, wherein said value is dependent on a life expectancy of said user calculated on the basis of said personal data.

14. A method according to claim 13, wherein said value is one of an estimated lifetime spend value, an estimated lifetime environmental impact value, an estimated lifetime time wasted value and a lifetime stress value.

15. A method according to claim 10, wherein each of said offer records includes information indicating an associated value, and step b) includes receiving a summed value of the associated values of the selected offer records.

16. In a system comprising a plurality of terminals connected or connectable to a host server and to any of a plurality of sponsor servers over a network, an offer database of offer records each including one or more offer criteria and a sponsor indication indicating one of said sponsor servers, and a user details database, both said databases being accessible to the host server, a method comprising:
a. submitting from one of the sponsor servers to the host server one or more offer records each including one or more offer criteria;
b. conducting transactions at said sponsor server with selected ones of said terminals redirected from said host server to said second server, said terminals being selected according to whether personal data submitted by said terminals matches said offer criteria; and
c. transmitting from said sponsor server to said host server compliance reports relating to said conducted transactions.

17. A method according to claim 16, including receiving at said sponsor server said personal data transmitted by said selected terminals.

18. A method according to claim 17, wherein said personal data is received via said host server.

19. A method according to claim 16, wherein said one or more offer records each include an associated value.

20. In a system comprising a plurality of terminals connected or connectable to a host server and to any of a plurality of sponsor servers over a network, an offer database and a user details database, both said databases being accessible to the host server, a method comprising:
a. receiving from each of said sponsor servers one or more offer records each including one or more offer criteria and an associated value, and storing said offer records on said offer database;
b. storing, on the user details database, personal data relating to a user;
c. comparing said personal data to the offer criteria and selecting a subset of said offer records for which the offer criteria match said personal data;
d. summing the associated values of the subset of said offer records to calculate a summed value; and
e. transmitting said summed value to one of said user terminals associated with said user.

21. In a system comprising a plurality of terminals connected or connectable to a host server, an offer database storing a plurality of offer records each including offer criteria and an associated offer value, and a user details database, both said databases being accessible to the host server, a method comprising:
a. transmitting, from one of said terminals associated with a user, personal data relating to said user for storage on said user details database; and
b. receiving at said terminal a summed value calculated as the sum of said associated values of a subset of said offer records for which the offer criteria match said personal data.

22. In a system comprising a plurality of terminals connected or connectable to a host server and a user details database accessible to the host server, a method comprising:
a. storing, on the user details database, personal data relating to a user;
b. calculating a value for said user dependent on a life expectancy of said user calculated on the basis of said personal data; and
c. transmitting said value to a terminal associated with said user.

23. A method according to claim 22, wherein said value is one of an estimated lifetime spend value, an estimated lifetime environmental impact value, an estimated lifetime time wasted value and a lifetime stress value.

24. In a system comprising a plurality of terminals connected or connectable to a host server, and a user details database accessible to the host server, a method comprising:
a. transmitting, from one of said terminals associated with a user, personal data relating to said user for storage on said user details database; and
b. receiving at said terminal a value dependent on a life expectancy of said user calculated on the basis of said personal data.

25. A method according to claim 24, wherein said value is one of an estimated lifetime spend value, an estimated lifetime environmental impact value, an estimated lifetime time wasted value and a lifetime stress value.

26. A method of conducting a game, comprising:
a. receiving as input a set of personal data relating to a participant in the game, indicating at least the age and risk factors of said person,
b. receiving an estimated lifetime value associated with that participant,
c. electronically calculating a lifetime value associated with that participant from said set of personal data and statistical information relating to life expectancy;
d. comparing said estimated lifetime value with said electronically calculated value; and
e. determining an outcome of said game as a result of said comparison.

27. A method according to claim 26, wherein said estimated lifetime value is one of an estimated lifetime spend value, an estimated lifetime environmental impact value, an estimated lifetime time wasted value and a lifetime stress value.

28. In a system comprising a plurality of terminals connected or connectable to a server over a network, and a database accessible to said server, a method comprising:
a. transmitting to one of said terminals a request for personal information relating to a user of said terminal;
b. receiving said personal information from said one of said terminals;
c. storing said personal information in said database; and
d. issuing a reward in response to receipt of said personal information; wherein said reward is linked directly or indirectly to an equity share in a company.

29. A method according to claim 28, including receiving a nomination indication from said user indicating a person or entity, and issuing said reward to the nominated person or entity.

30. A method according to claim 29, including transmitting information from said database to a party, and receiving from said party a payment to said company.

31. A method according to claim 30, including receiving a request for said information from said party, transmitting a request for said information to said user, and receiving said information from said user.

32. A method according to claim 31, wherein said request for said information includes a user selection criterion, and said request is transmitted to said user only if said user satisfies said criterion.

33. In a system comprising a plurality of terminals connected or connectable to a server over a network, and a database accessible to said server, a method comprising:
a. receiving from said server at one of said terminals a request for personal information;
b. transmitting said requested personal information relating to a user from said terminal to said server; and
c. receiving a reward in response to receipt of said personal information; wherein said reward is linked directly or indirectly to an equity share in a company.

34. A method according to claim 33, including transmitting a nomination indication from said user to said server, the nomination indication indicating a person or entity to receive said reward.

35. A computer-readable medium encoded with a computer program arranged to perform the method of any one of claims 1, 16, 20, 22, 26, and 28.

36. A server arranged to perform the method of any one of claims 1, 16, 20, 22, 26 and 28.
